(19) United States
(12) Patent Application Publication
(10) Pub. No.: US 2016/0057674 A1
(43) Pub. Date: Feb. 25, 2016

(54) WIRELESS COMMUNICATION SYSTEM, WIRELESS COMMUNICATION METHOD, AND WIRELESS BASE STATION

(71) Applicant: HITACHI, LTD., Tokyo (JP)

(72) Inventors: Eriko TAKEDA, Tokyo (JP); Takashi ISHIKAWA, Tokyo (JP); Satoshi TAMAKI, Tokyo (JP); Go ONO, Tokyo (JP); Katsuhiko TSUNEHARA, Tokyo (JP); Kenzaburo FUJISHIMA, Tokyo (JP)

(21) Appl. No.: 14/235,464

(22) PCT Filed: Mar. 15, 2013
(86) PCT No.: PCT/JP2013/057339

§ 371 Date: Jan. 28, 2014

(51) Int. Cl. H04W 36/16; H04W 36/08

(52) U.S. Cl. CPC H04W 36/16; H04W 36/08

(57) ABSTRACT

The invention is intended to, even in a situation where there are many candidate wireless base stations (WBSs) to which a mobile terminal (MT) may connect, get information of communication conditions between the MT and each of those WBSs and determine an WBS to which the MT should connect in a shorter time. A coverage area of the first WBS is overlapped partially at least by a coverage area of the second WBS. The MT transmits a signal for connection using a predetermined frequency. Upon receiving the signal for connection, the second WBSs each notify the WBS communication manager of their reception results of the signal for connection. The WBS communication manager selects a second WBS to communicate with the MT based on the reception results and notifies the selected second WBS to transmit a response signal to the signal for connection to the MT.

### BACKGROUND

The present invention relates to a wireless communication technique for use in a wireless communication system comprised of a mobile terminal and a plurality of wireless base stations.

When a mobile terminal initiates communication with a wireless base station, if there are a plurality of candidates of wireless base stations with which the terminal may communicate by radio, for example, the following method is used: the mobile terminal measures received signal power from each of the wireless base stations, determines a wireless base station which is best suited to the communication according to the measurement results, and transmits a connection request signal to that wireless base station (related art example 1).

In a state in which a mobile terminal is already communicating with a wireless base station (WBS), if a handover to another WBS is required by a situation such that the mobile terminal has moved into a poor radio propagation environment, for example, the following method is taken: the mobile terminal receives a list of information on wireless base stations (WBSs) existing in its neighborhood from its serving WBS with which it is now communicating and reports received power from the WBSs chosen as candidates to the serving WBS and, from the report result, the serving WBS determines a new WBS to which the mobile terminal is to connect (related art example 2).

Japanese Unexamined Patent Application Publication No. 2008-8589, which is hereinafter referred to as Patent Document 1, focuses on a handover case and discloses a cell search method for a handover in a wireless communication system using a plurality of frequency bands. This method is outlined below. In Patent Document 1, a list of information on surrounding base stations is provided as a surrounding base station list. In order to enable notifying a mobile station of a base station list containing a larger number of base stations chosen as suitable handover target candidates, base stations are classified into a plurality of first categories according to their cell size and classified into a plurality of second categories according to their radio frequency band. The first and second categories are associated with levels of mobile station moving speed. The moving speed of the mobile station of interest is acquired. According to the acquired moving speed of the mobile station, at least one of the first categories and at least one of the second categories are selected. Based on information on base stations that belong to the selected first and second categories, a base station list is created and notified to the mobile station. The mobile station performs cell search based on the base station list notified to it.

### SUMMARY

In the related art examples 1 and 2 and Patent Document 1, a mobile terminal (MT) measures received signal power from a wireless base station (WBS) through one-to-one communication between the MT and the WBS and repeats taking this measurement as many times as the number of WBSs chosen as connection target candidates. Consequently, if there are many WBSs chosen as candidates to which the MT may connect and initiate communication, it takes time to determine which WBS to which the MT should connect and initiate communication.

Therefore, the present invention is intended to provide a wireless communication system, method, and apparatus designed to, in a situation where there are many WBSs chosen as connection target candidates, get information of communication conditions between the MT of interest and each of those WBSs and determine an WBS to which the MT should connect in a shorter time than ever before.

A typical aspect of the invention disclosed in the present application is briefly outlined below.

There is provided a wireless communication system including a mobile terminal, a first wireless base station (WBS) that uses a first frequency band to communicate with the mobile terminal, a plurality of second WBSs that use a second frequency band which is different from the first frequency band to communicate with the mobile terminal, and an WBS communication manager connected to the first WBS and the second WBSs. A coverage area of the first WBS is overlapped partially at least by a coverage area of the second WBS. The mobile terminal transmits a signal for connection using a predetermined frequency. Upon receiving the signal for connection, the second WBSs each notify the WBS communication manager of their reception results of the signal for connection. The WBS communication manager selects a second WBS to communicate with the mobile terminal based on the reception results and notifies the selected second WBS to transmit a response signal to the signal for connection to the mobile terminal.

According to the present invention, in a situation where there are many candidate WBSs to which a mobile terminal (MT) may connect, it is possible to get information of communication conditions between the MT and each of those WBSs and determine an WBS to which the MT should connect in a shorter time than ever before.

Problems, configurations, and advantageous effects other than described above will be more apparent from the following description of embodiments.

### BRIEF DESCRIPTION OF THE DRAWINGS

FIG. 1 is a diagram depicting a concept of how a plurality of wireless base stations (WBSs) and their coverage areas have relationships to one another according to a first embodiment;

FIG. 2 is a diagram depicting an example of how the WBSs are organized according to the first embodiment;

FIG. 3 is a diagram depicting an example of an operation sequence among a mobile terminal (MT), WBSs, and an WBS communication manager according to the first embodiment;

FIG. 4 is a diagram depicting an example of a functional configuration of a mobile terminal according to the first embodiment;

FIG. 5 is a diagram depicting an example of a functional configuration of a wireless base station (WBS) A according to the first embodiment;

FIG. 6 is a diagram depicting an example of a hardware configuration of the WBS communication manager according to the first embodiment;

FIG. 7 is a diagram depicting an example of an operation sequence among a mobile terminal (MT), WBSs, and the WBS communication manager according to the first embodiment;

FIG. 8 is a diagram depicting an example of a flowchart of operation of the MT according to the first embodiment;

FIG. 9 is a diagram depicting an example of an operation sequence among a mobile terminal (MT), WBSs, and the WBS communication manager according to a second embodiment;

FIG. 10 is a tabular representation of an example of information on the WBSs that is transmitted by the WBS A to the MT according to the second embodiment;

FIG. 11 is a tabular representation of an example of information on the WBSs that is transmitted by the WBS A to the MT according to the second embodiment;

FIG. 12 is a diagram depicting an example of an operation sequence among a mobile terminal (MT), WBSs, and the WBS communication manager according to the second embodiment;

FIG. 13 is a diagram depicting an example of a flowchart of an operation for determining a priority order of frequencies to be used for the MT to transmit a signal for connection according to the second embodiment;

FIG. 14 is a diagram depicting an example of a functional configuration of a mobile terminal according to the second embodiment;

FIG. 15 is a diagram depicting an example of an operation sequence among a mobile terminal (MT), WBSs, and the WBS communication manager according to a third embodiment;

FIG. 16 is a diagram depicting an example of an operation sequence among a mobile terminal (MT), WBSs, and the WBS communication manager according to a fourth embodiment;

FIG. 17 is a diagram depicting an example of an operation sequence among a mobile terminal (MT), WBSs, and the WBS communication manager according to a fifth embodiment;

FIG. 18 is a tabular representation of an example of information on the WBSs that is transmitted by an WBS to the MT according to the fifth embodiment;

FIG. 19A is a diagram schematizing the antenna beam forms of WBSs according to a sixth embodiment; and

FIG. 19B a diagram schematizing the antenna beam forms of WBSs according to the sixth embodiment.

### DETAILED DESCRIPTION

Embodiments of the present invention will be described below by way of the drawings.

In embodiments described herein, different frequencies do not mean different frequency bands provided by dividing, e.g., a continuous frequency range into several frequency bands. They refer to discontinuous and discrete frequency bands, for example, a 700 MHz band and a 2 GHz band.

In the following description of embodiments, a plurality of separate sections or embodiments are described, where necessary for convenience. Unless otherwise stated, however, these sections or embodiments are not independent of each other and they correlate such that one section or embodiment provides a modification example, details, or supplementary explanation of a part or all of another section or embodiment. The embodiments may be carried out either separately or in combination.

In the following description of embodiments, where a number is specified, such as the number of elements (as well as the number of entities, a value, an amount, a range, etc.), such number is not limited to the specified number and may be more or less than the specified number, unless otherwise stated or unless such number is, in principle, obviously limited to the specified number.

Moreover, in the following description of embodiments, it goes without saying that a constituent element (as well as a constituent step or the like) may not always be a requisite, unless otherwise stated or unless such element or step is, in principle, obviously considered as a requisite.

Likewise, in the following description of embodiments, when a shape of a constituent element or the like, a positional relation, or the like is described, such description should be construed as including those approximate to or similar to the shape or the like, unless otherwise stated or unless such description is, in principle, considered not to include those obviously. This is also true for a value and a range that are specified.

In the following, various embodiments will be described in detail.

### First Embodiment

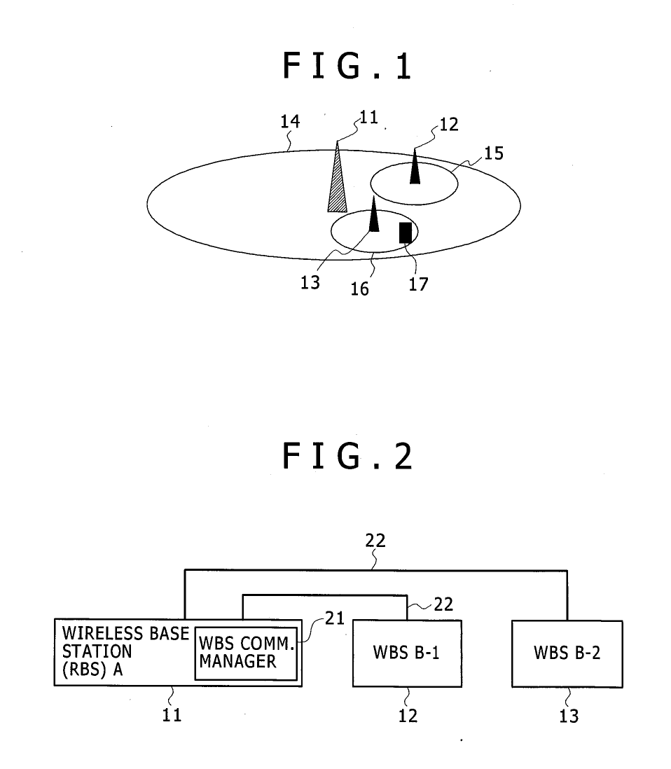

FIG. 1 is a diagram depicting a concept of how a plurality of wireless base stations and their coverage areas have relationships to one another according to a first embodiment. A wireless communication system according to the first embodiment is comprised of one wireless base station (WBS) A (11), two wireless base stations B-1 (12), B-2 (13) which perform communication using a frequency band different from that used by the WBS A, and a mobile terminal (17) that communicates with any WBS. A frequency band that is used by the WBS A for communication with a mobile terminal will hereinafter be referred to as frequency A and a frequency band that is used by the WBS B-1 and the WBS B-2 for communication with a mobile terminal will hereinafter be referred to as frequency B. For example, the frequency A is a 700 MHz band and the frequency B is a 2 GHz band. These WBSs are deployed so that the coverage area (15) of the WBS B-1 and the coverage area (16) of the WBS B-2 are overlapped to the coverage area (14) of the WBS A.

FIG. 2 is a diagram depicting how the WBSs are organized according to the first embodiment. The WBS A has inside it an WBS communication manager (21) that manages communication of three WBSs: WBS A, WBS B-1, and WBS B-2.

The WBS communication manager manages at least the frequencies that are used by the WBS A, WBS B-1, and WBS B-2. The WBS communication manager is also capable of managing information other than the frequencies, such as, for example, a maximum communication rate of each WBS and moving speed of the mobile terminal supportable by each WBS. The WBS communication manager is provided with a function for transmitting a command to instruct each WBS to perform an operation, not only receiving information from each WBS. The WBS communication manager and each of the WBSs can communicate with each other.

In the first embodiment, an organization in which the WBS communication manager is provided inside the WBS A is proposed. By providing the WBS communication manager inside the WBS A, space saving can be achieved, as compared with a case in which the WBS communication manager is installed as a separate device. However, this organization of the first embodiment is one example and the WBS communication manager may be provided in another location as a single device, provided that it can communicate with the WBS A, WBS B-1, and WBS B-2. The WBS communication manager and each WBS may be connected by wireless links. In this case, wiring between them becomes unnecessary and the organization becomes easy to change. A radio frequency that is used for this purpose may be equal to a frequency that is used by each WBS for communication with a mobile terminal or may be a different frequency.

In the first embodiment, the WBS B-1, WBS B-2, and WBS A are interconnected by wiring (22) and an arrangement is made so that they can connect to the WBS communication manager existing inside the WBS A. By exchanging information between WBSs via wired lines, there is no need for using wireless resources for other purposes than communication with a mobile terminal. Each WBS is allowed to perform communication with the WBS communication manager at desired timing without taking account of communication conditions of other WBSs.

Of course, the system may use both wired lines and wireless links, instead of using only wired lines or only wireless links.

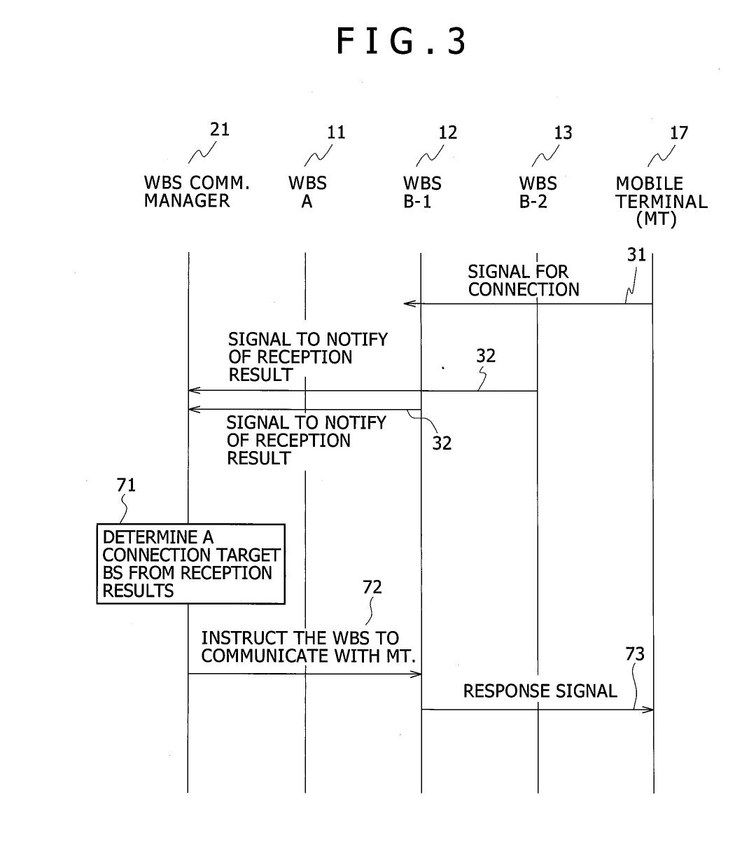

Then, operation of the wireless communication system according to the first embodiment is described using an operation sequence among a mobile terminal (MT), WBSs, and the WBS communication manager depicted in FIG. 3. When the MT wants to communicate with a WBS, the MT transmits a signal for connection using one frequency usable by the MT, with predetermined power, and at given timing (31). The signal for connection is a signal to be transmitted when the MT requests any WBS to communicate with it. An arrangement is made such that a WBS having received the signal for connection is to transfer, for example, a received power as a signal to notify of reception result to the WBS communication manager.

In the present embodiment, operation is described in a situation where the MT selects the frequency B as an optional frequency from among the frequencies usable by the MT and transmits the signal for connection with the frequency B and, then, the WBS B-1 and WBS B-2 have successfully received the signal for connection. The WBS B-1 and WBS B-2 notify the WBS communication manager of received signal power as the signal to notify of reception result (32).

The WBS communication manager determines a connection target WBS from reception results (71) and transmits to the connection target WBS a signal to instruct the WBS to communicate with the MT (72). Upon receiving that signal, the WBS transmits a response signal to the MT (73). FIG. 3 presents the operation sequence in a case in which the WBS B-1 was determined as the WBS to which the MT should connect.

In this framework, one signal transmission from the MT enables the WBS communication manager to acquire information for comparing the received power values of the WBS B-1 and WBS B-2 to determine which of them is larger.

By following the foregoing operation sequence, it is possible to get information of communication conditions between the MT and each of the WBSs using the same frequency in a shorter time and with less wireless resources than in a case in which a measurement of received power is taken through one-to-one communication between MT and WBS and this measurement is repeated as many times as the number of WBSs chosen as connection target candidates. Then, the WBS communication manager can determine a WBS that is best suited to communication with the MT and the MT and the WBS can initiate communication.

Although there are two WBSs that use the same frequency for communication in the first embodiment, this number is not limited to 2. This method can be applied for a case in which those WBSs are three or more. Obviously, the larger the number of WBSs that use the same frequency for communication, the larger will be the advantage that shortens the time required to get information of communication conditions between the MT and each of the WBSs, as compared with in the case of getting information of communication conditions between MT and WBS by repeating one-to-one communication between MT and WBS.

Next, descriptions are provided for the detailed configurations of a mobile terminal and a wireless base station in the wireless communication system of the present embodiment. In the following, descriptions are provided about functional blocks related to MT and WBS operations in the present embodiment. However, other functional blocks may be added as constituent elements. In a wireless base station, for example, a function for synchronization and an external interface or the like for exchanging information with other devices may be provided as necessary.

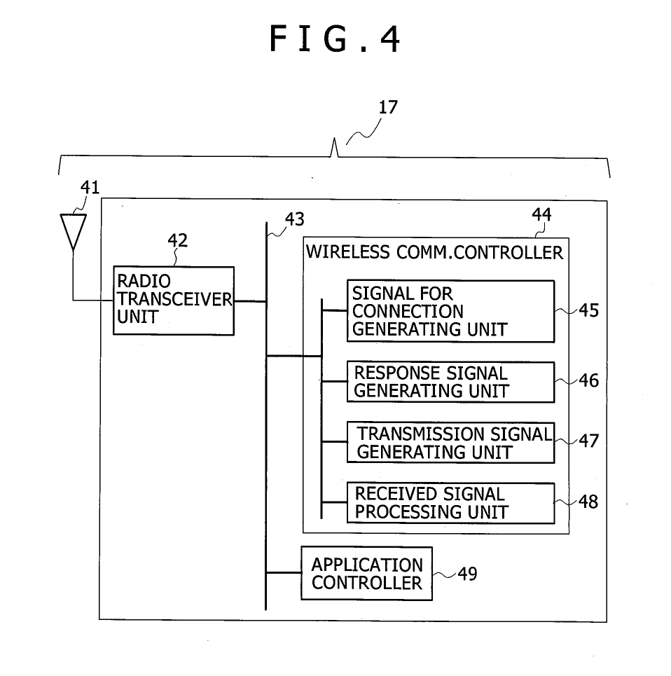

Then, a configuration of a mobile terminal in the wireless communication system of the first embodiment is described using FIG. 4. The mobile terminal 7 is configured to include at least an antenna 41, a radio transceiver unit 42, a wireless communication controller 44, and an application controller 49. The radio transceiver unit 42, wireless communication controller 44, and application controller 49 are interconnected by a bus 42 and can exchange a signal with each other.

The radio transceiver unit is configured to include at least a radio front-end unit and a baseband unit. A MAC unit may be included in either the radio transceiver unit or the wireless communication controller. Both the wireless communication controller and the application controller can typically be configured with a CPU and a memory or the like. The CPU executes various programs stored in the memory, so that various functions can be implemented. The wireless communication controller transmits and receives a radio signal to/from a wireless base station.

The wireless communication controller in the first embodiment is configured to include a transmission signal generating unit 47 that generates a data signal or the like which is transmitted to a wireless base station and a received signal processing unit 48 that processes a signal received from a wireless base station; and, besides, a signal for connection generating unit 45 that generates a signal for connection which is used to connect to a wireless base station as a function specific to the present embodiment and a response signal processing unit 46 that processes a response signal transmitted from a wireless base station in response to a signal for connection.

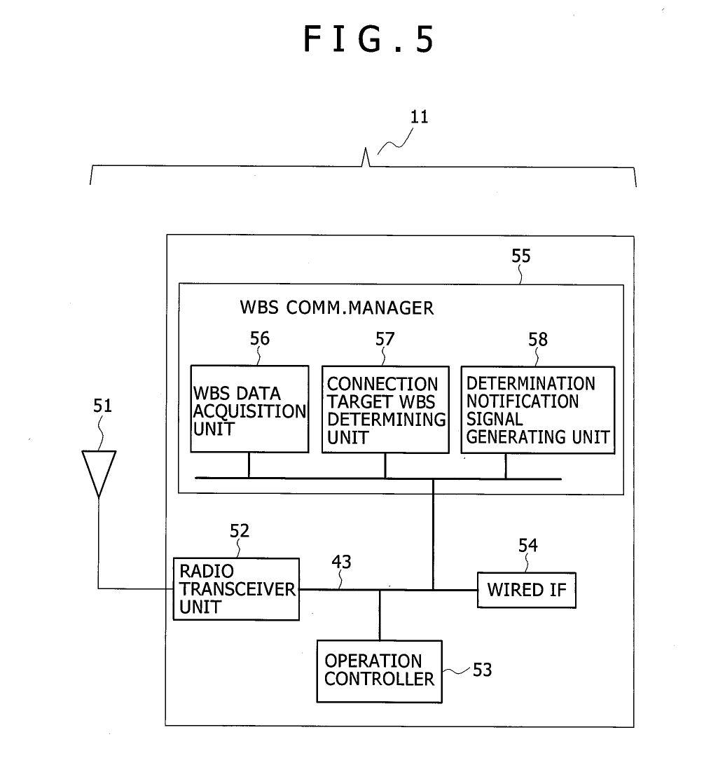

Then, a configuration of the WBS A in the wireless communication system of the first embodiment is described using FIG. 5. The WBS B-1 and WBS B-2 have the same configuration as the WBS A with the exception that they do not have the WBS communication manager and the frequency used by them for wireless communication with MT is different from the frequency used by the WBS A.

The WBS A is comprised of a wired interface 54, a radio transceiver unit 52, a bus 43, an antenna 51, and an operation controller 53 and is configured to further include the WBS communication manager 55. The wired interface 54 is an interface with other WBSs and a backhaul or the like. The radio transceiver unit 52 performs wireless communication with a mobile terminal via the antenna 51. A signal received via the wired interface 54 and a signal generated within the WBS, for example, in the WBS communication manager are converted to a radio signal in the radio transceiver unit. The configuration of the radio transceiver unit 52 of the WBS may be the same as the configuration of the radio transceiver unit of the mobile terminal. The operation controller of the WBS controls various operations of the WBS. Because it can be configured with a CPU and a memory or the like, its description is here dispensed with.

Then, the WBS communication manager 55 is described. The WBS communication manager is configured to include at least a WBS data acquisition unit 56, a connection target WBS determining unit 57, and a determination notification signal generating unit 58. Received power measurements notified from the WBSs having received a signal for connection from the MT are collected by the WBS data acquisition unit. The connection target WBS determining unit compares the received power values of the WBSs and determines which WBS is best suited to communication with the MT. In the present embodiment, it is arranged that a WBS with the largest received power is determined to be best suited to communication with the MT. However, the criterion for determining which WBS is best suited to communication with the MT is not only received power and other conditions may be added to the criterion. For example, if there are a plurality of WBSs with substantially the same received power, the number of MTs being now connected to and served by each WBS may be added as a criterion condition. By this criterion, the connection target WBS determining unit may select a WBS serving a fewer number of MTs being now connected to it, if the received power measurements are substantially the same.

The determination notification signal generating unit 58 generates a signal to notify the WBS determined to communicate with the MT that it was determined as the WBS to communicate with the MT. The WBS having received this signal generates a response signal to the signal for connection transmitted by the MT in its operation controller and transmits the response signal to the MT.

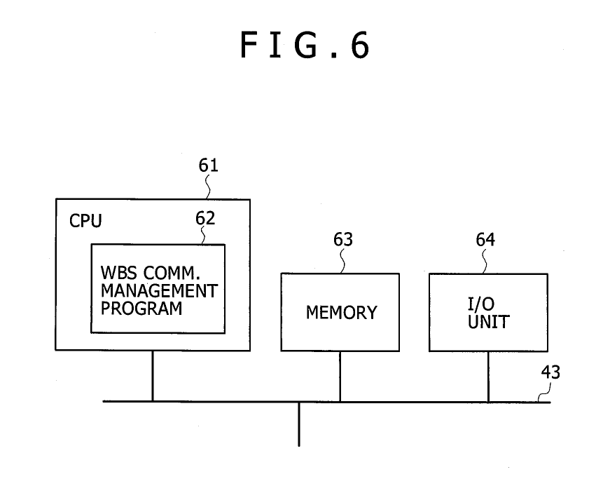

One example of a hardware configuration of the WBS communication manager 55 is depicted in FIG. 6. The WBS communication manager can be implemented as a typical computer configuration which includes, along with a bus 43, a Central Processing Unit (CPU) 61 as a processor and a memory 63 as a storage unit and may further include an input/output unit 64 as necessary. The CPU 61 executes a WBS communication management program 62 which is software for performing operations required in the present embodiment, including comparing the received power values of the WBSs, determining a WBS that is best suited to communication with the MT, and generating a signal to notify the WBS of the determination, as described previously. This program is stored in the memory 63 or the like and executed by the CPU 61, as needed, to implement the foregoing functions or various functions, which will be described subsequently, of the WBS communication manager. A software program for performing operations required for a mobile terminal as well as a software program for performing operations required for a wireless base station in the present embodiment can also be implemented in the same hardware configuration as depicted in FIG. 6.

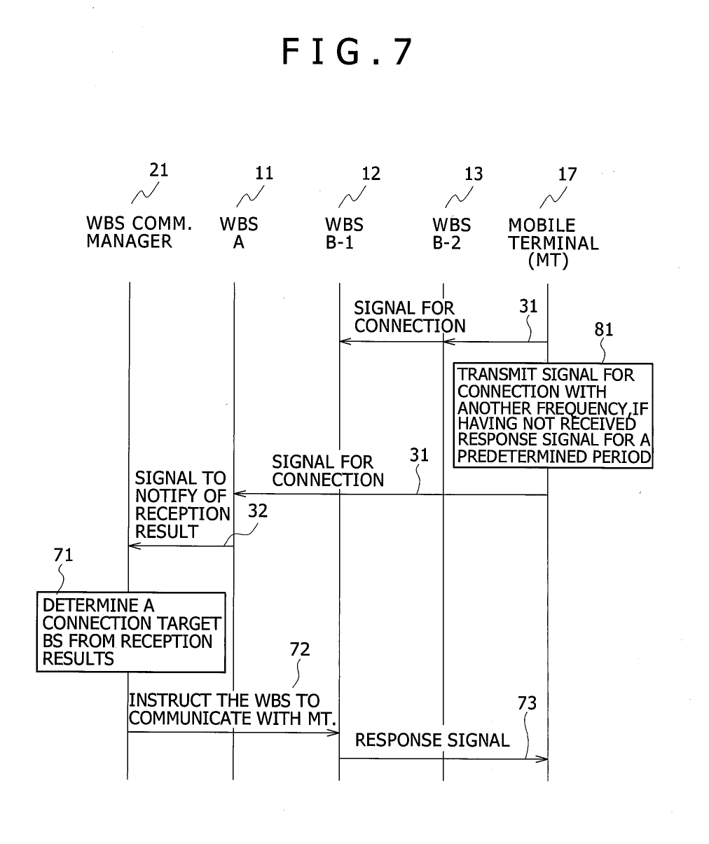

Next, another operation sequence among a mobile terminal (MT), WBSs, and the WBS communication manager according to the first embodiment is described using FIG. 7. Description with regard to FIG. 7 concerns only a point of difference from the operation sequence of FIG. 3. FIG. 7 represents the operation sequence in such a situation that the MT first transmitted a signal for connection using a frequency, but no WBS can receive that signal at the frequency, or that the MT is far from any WBS, or that the signal with strong power enough to be detectable by WBS does not arrive at any WBS because of the presence of an obstacle or the like.

In this situation, because received power information is not notified from any WBS to the WBS communication manager, the WBS communication manager cannot determine a WBS to which the MT should connect and, consequently, the MT cannot receive a response signal. Therefore, the MT is to transmit a signal for connection with another frequency, if having not received a response signal for a predetermined period of time (81).

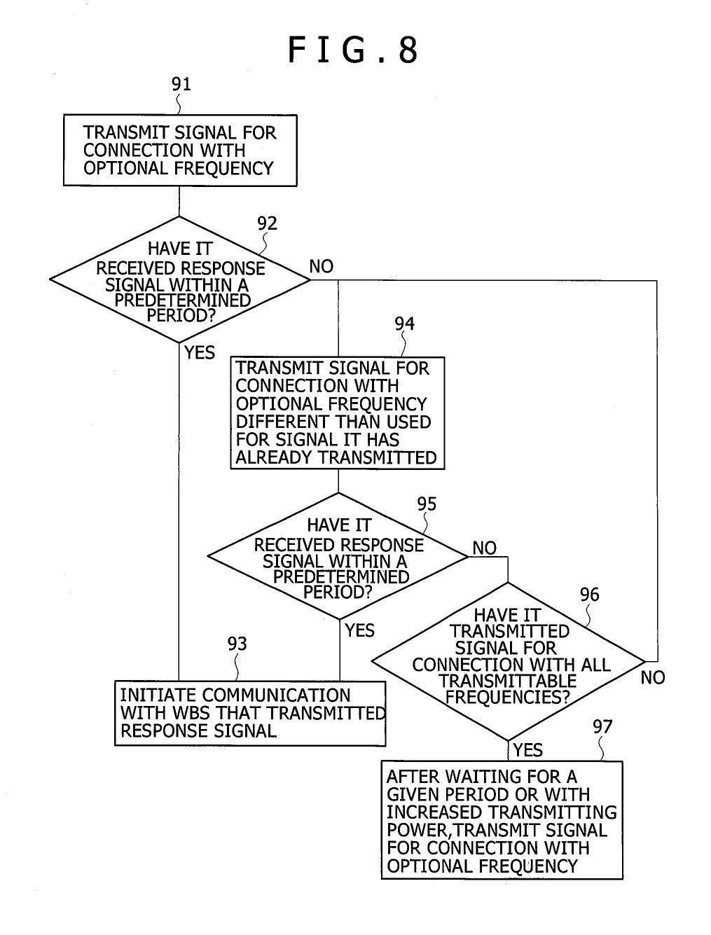

A flowchart of operation of the MT in this context is described using FIG. 8. In the present embodiment, the MT transmits a signal for connection with an optional frequency which is one of frequencies that can be used by it to communicate with a WBS (91) and decides whether it has received a response signal from a WBS within a predetermined period of time (92). If the decision is Yes, the MT initiates communication with the WBS that transmitted the response signal (93). If the decision is No, the MT transmits a signal for connection with an optional frequency different than used for the signal it has already transmitted (94) and decides whether it has received a response signal within a predetermined period of time (95). If the decision is Yes, the MT initiates communication with the WBS that transmitted the response signal (93). If the decision is No, the MT decides whether it has transmitted the signal for connection with all transmittable frequencies (96). If the decision is No, the MT transmits a signal for connection with an optional frequency different than used for the signal it has already transmitted (94). If the decision is Yes, after waiting for a given period or with increased transmitting power, the MT transmits a signal for connection using an optional frequency which is one of frequencies that can be used by it to communicate with a WBS (97).

In the present embodiment, the MT is arranged to optionally select a frequency that is used to transmit a signal for connection. Even if the MT has transmitted the signal for connection using all frequencies that can be transmitted by the MT, if the MT still failed to receive a response signal from an WBS, the MT repeats transmission of the signal for connection using the frequencies it has already used. In this case, selecting one of the frequencies to transmit the signal for connection may be done in the same order of the frequencies as done for the first time or may be arranged to change the order of the frequencies randomly.

In the present embodiment, it is arranged that the MT optionally selects a frequency that is used to transmit the signal for connection out of the frequencies that can be transmitted by the MT and transmits it. If the transmitting power and the antenna gain are constant, it is generally thought that a lower frequency signal experiences less attenuation and its signal arrival range is wider. Thus, it may be arranged that one of the frequencies that can be transmitted by the MT is selected in ascending order from the lowest frequency and used to transmit the signal for connection.

The system may be arranged such that, if the MT fails to receive a response signal after the first transmission of the signal for connection, the MT retransmits the signal for connection with increased transmitting power at the same frequency before transmitting the signal with another frequency.

As described above, according to the first embodiment of the present invention, even in a situation where there are many candidate WBSs to which the MT may connect, the WBS communication manager is able to get information of communication conditions between the MT and each of the WBSs and determine a new WBS to which the MT is to connect with less wireless resources and in a shorter time than ever before.

### Second Embodiment

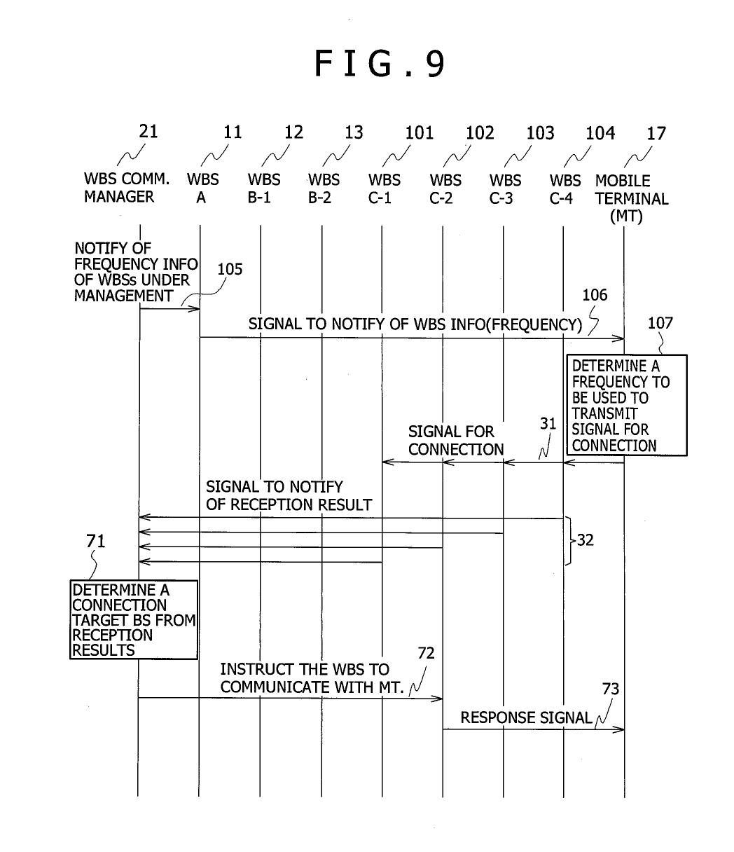

Next, an operation sequence among a mobile terminal (MT), WBSs, and the WBS communication manager according to a second embodiment is described using FIG. 9. In the second embodiment, WBS A, WBS B-1, WBS B-2, WBS C-1 (101), WBS C-2 (102), WBS C-3 (103), and WBS C-4 (104) exist. A frequency band that is used by the WBS A for communication with a mobile terminal will hereinafter be referred to as frequency A. A frequency band that is used by the WBS B-1 and the WBS B-2 for communication with a mobile terminal will hereinafter be referred to as frequency B. A frequency band that is used by the WBS C-1, WBS C-2, WBS C-3, and WBS C-4 for communication with a mobile terminal will hereinafter be referred to as frequency C. In the present embodiment, the frequencies of the WBSs are such that the frequency B is higher than the frequency A and the frequency C is higher than the frequency B.

The sequence of FIG. 9 is arranged such that the WBS communication manager notifies the WBS A of frequency information of the WBSs under management (105) and the WBS A notifies the MT of that information, which is a point of difference from the operation sequence of the first embodiment. In the present embodiment, operation is described in a situation where the MT can receive a signal with the frequency A. By receiving the frequency information, the MT can select a frequency to transmit a signal for connection out of the frequencies in a frequency band that can be transmitted by the MT and matches with a frequency band that can be received by WBS (107). In this framework, it can be avoided that the MT transmits a signal for connection using a frequency that cannot be received by WBS from the beginning.

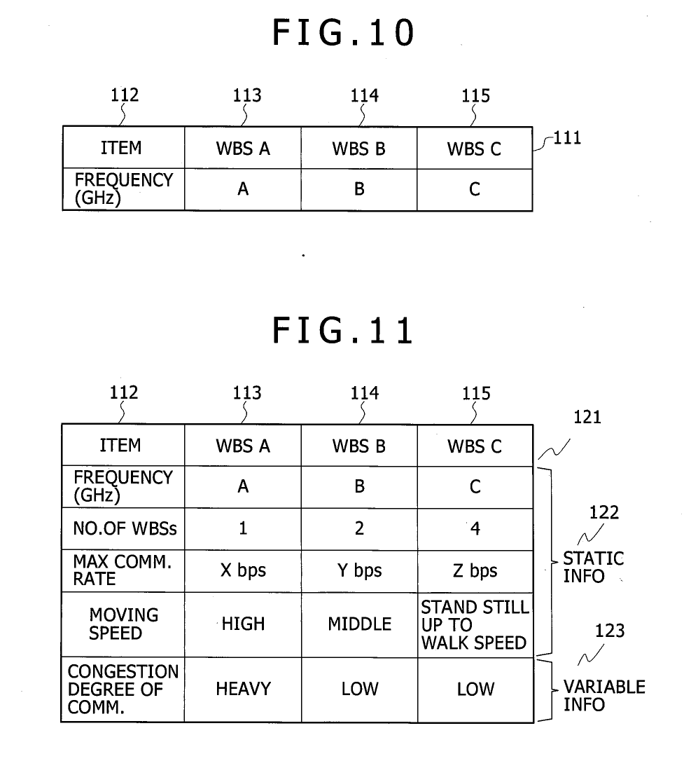

FIG. 10 is a tabular representation of information 111 on the WBSs that is transmitted by the WBS A to the MT according to the second embodiment. By receiving this information, the MT knows that, as WBSs that can communicate with the MT using specific frequency, there are WBS B (114) using frequency B for communication and WBS C (115) using frequency C for communication, besides the WBS A (113).

Moreover, information 121 on the WBSs, as presented in FIG. 11, may be notified to the MT via the WBS A. Information on the WBSs represented in FIG. 11 includes static information (122) which is not changed frequently, such as frequency, the number of WBSs using that frequency for communication, maximum communication rate, and supportable moving speed of MT; and variable information (123) which varies over time, such as the congestion degree of communication of each WBS. Thus, a way to notify of static information and variable information separately, as will be described later, may be used.

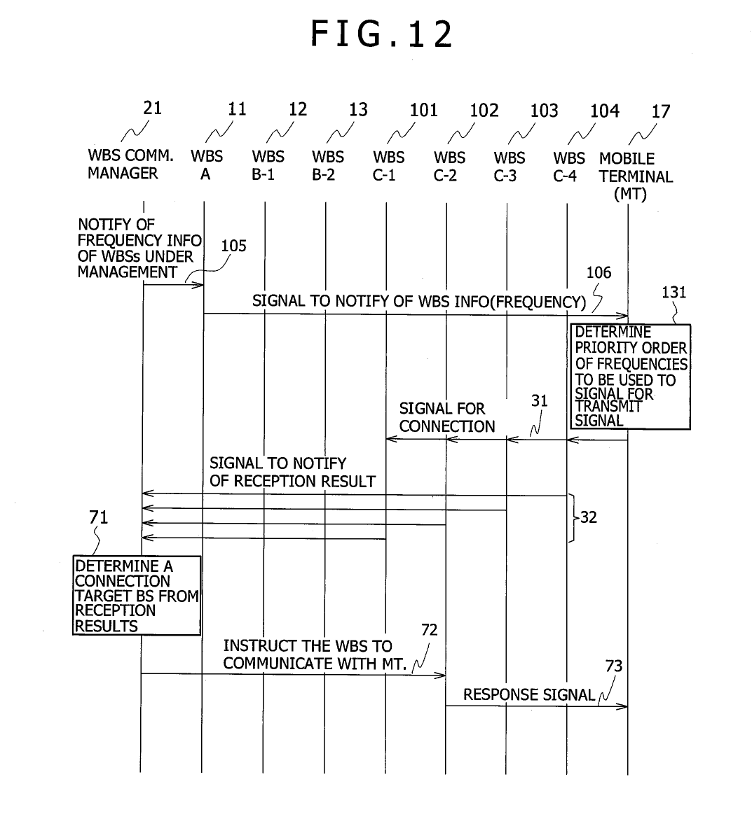

Another operation sequence among a mobile terminal (MT), WBSs, and the WBS communication manager according to the second embodiment is described using FIG. 12. By receiving a signal to notify of the characteristics of the WBSs, the MT can determine a priority order of frequencies to be used for the MT to transmit a signal for connection (131).

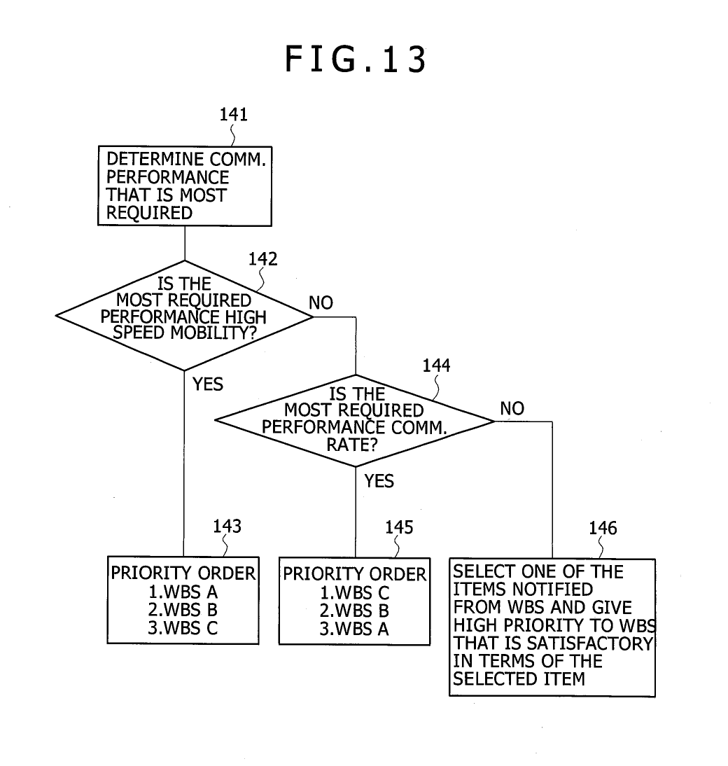

A flowchart of an operation for determining a priority order of frequencies to be used for the MT to transmit a signal for connection according to the second embodiment is depicted in FIG. 13. The MT determines what communication performance is most required by it (141). If the most required performance is high speed mobility (142), the MT determines the priority order according to ascending order of the frequencies: i.e., the first rank is WBS A, the second is WBS B, and the third is WBS C. If the most required performance is communication rate (144), the MT determines the priority order by ranking the WBSs according to descending order of their communication rates (145). In the embodiment depicted in FIG. 12, WBS C having the highest communication rate ranks the top, WBS B follows as second, and the last is WBS A. If the most required performance is neither high speed mobility nor communication rate, the MT selects one of the items notified from the WBS and gives high priority to an WBS that is satisfactory in terms of the selected item (146).

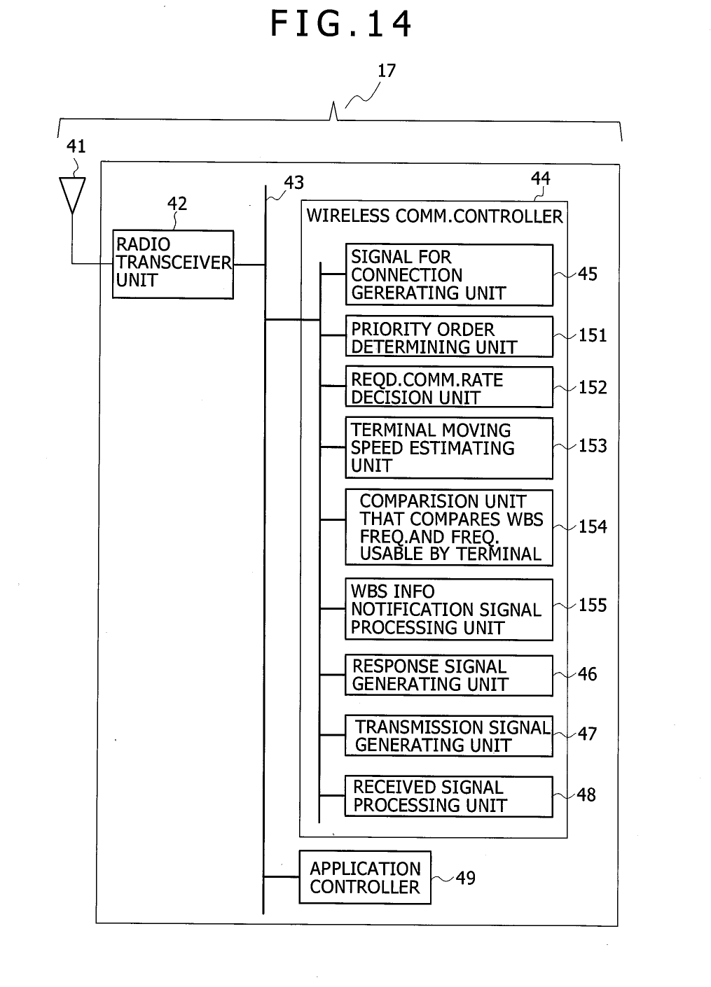

A functional configuration of a mobile terminal that performs the foregoing operation is depicted in FIG. 14. The following description concerns only a point of difference from the functional configuration of a mobile terminal depicted in FIG. 4. The mobile terminal according to the second embodiment has, in the wireless communication controller, a priority order determining unit 151, a required communication rate decision unit 152, a terminal moving speed estimating unit 153, a comparison unit that compares WBS frequency and frequency usable by terminal 154, and a WBS information notification signal processing unit 155.

In the mobile terminal (MT) of the second embodiment, the WBS information notification signal processing unit 155 obtains information of usable frequencies from information transmitted from the WBS. The comparison unit that compares WBS frequency and frequency usable by terminal compares a frequency that is used by a WBS and a frequency that can be used by the MT and extracts a matched frequency. The priority order determining unit determines which frequency should be used according to the flowchart depicted in FIG. 13. The required communication rate decision unit decides on a required communication rate suitable for the application, for example, depending on what application the MT uses. The terminal moving speed estimating unit estimates the moving speed of the MT, for example, through the use of GPS. The way in which the MT determines a priority order is not limited to that described with the flowchart depicted in FIG. 13. The MT may determine a priority order, taking account of a combination of some of the items depicted in FIG. 11. In this case, the MT may make this determination comprehensively, using results calculated or estimated by the required communication rate decision unit or the terminal moving speed estimating unit.

Since the MT selects one of the frequencies that the MT can transmit and transmits a signal for connection with the selected frequency in the first embodiment, it may occasionally happen that the MT transmits a signal for connection with a frequency that cannot be received by WBS. Now, the framework of the second embodiment, as described above, can prevent the MT from transmitting a signal for connection with a frequency that is not used by WBS. It is possible to provide a system in which an operation of connecting a mobile terminal to a WBS is carried out more certainly and efficiently.

In the second embodiment, information such as the frequencies of all WBSs is transmitted from a WBS that uses the lowest frequency for communication. This provides an advantage that the information can be delivered far in a widespread range. As information on the WBSs, information other than the frequencies may be notified to the MT, so that the MT can determine a priority order of the frequencies to transmit a signal for connection, taking account of the information other than the frequencies as well.

### Third Embodiment

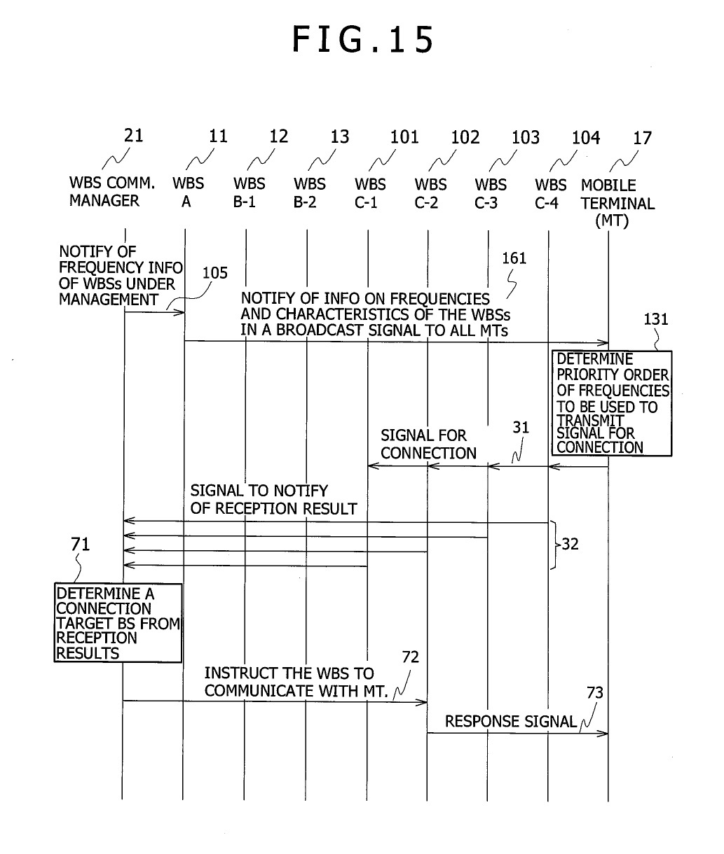

An operation sequence among a mobile terminal (MT), WBSs, and the WBS communication manager according to a third embodiment is described using FIG. 15. In the present embodiment, it is arranged that, in a broadcast signal that the WBS A transmits to all mobile terminals periodically, information on the frequencies and characteristics of the WBSs are notified along with a signal for synchronization and information of timing to access the WBSs (161). Other operation details are the same as in the operation sequence described using FIG. 13.

In the third embodiment, information for synchronization, information of timing to access the WBSs, and information on all the WBSs can be transmitted at a time, contained in a broadcast signal. Thus, an operation of connecting a mobile terminal to a WBS can be carried out more efficiently than in a case in which the MT receives these particulars of information separately.

Although, in the second and third embodiments, it is arranged that information on the WBSs is notified from the WBS A, it may be arranged that such information is notified from another WBS. It may also be arranged so that such information is notified from a plurality of WBSs not a signal WBS. Such notification may also be transmitted with a plurality of frequencies not a single frequency. By transmitting the notification from a plurality of WBSs and with a plurality of frequencies, it is possible to increase the likelihood that a mobile terminal receives the broadcast signal, as compared with the case of transmitting the notification with a signal frequency from a single WBS.

### Fourth Embodiment

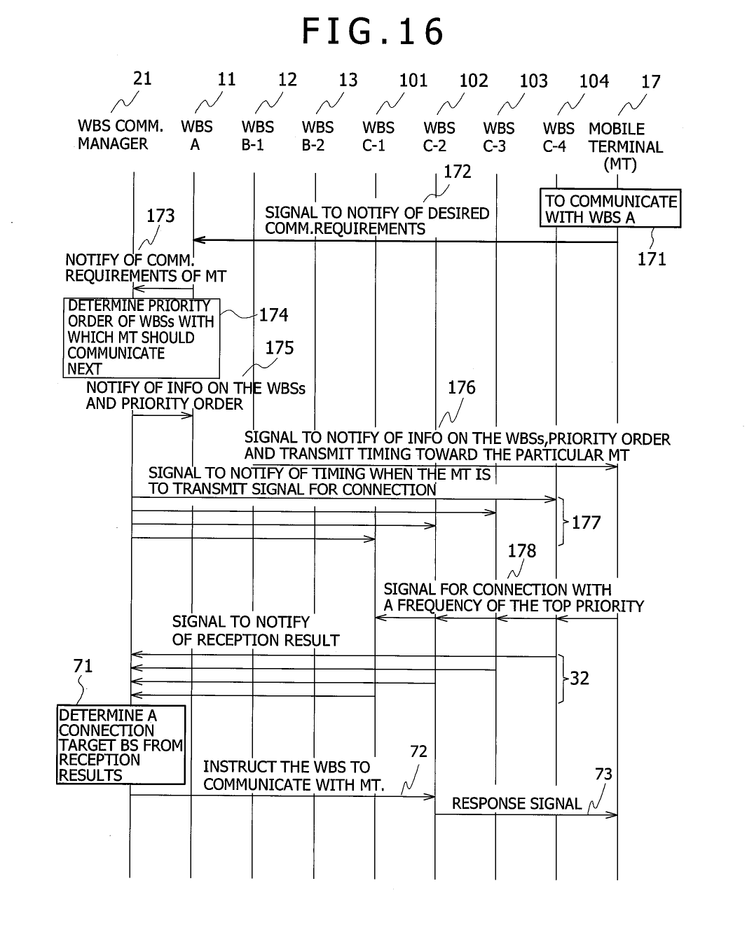

An operation sequence among a mobile terminal (MT), WBSs, and the WBS communication manager according to a fourth embodiment is described using FIG. 16. FIG. 16 depicts the operation sequence among a mobile terminal (MT), WBSs, and WBS communication manager, when the MT has moved into the coverage area of a WBS managed by the WBS communication manager from the area of a WBS that is other than the WBSs managed by the WBS communication manager. The operation sequence is presented here in a situation where the MT first connects to a WBS A that uses the lowest frequency and, then, the MT is handovered to a more suited WBS according to communication requirements of the MT.

In FIG. 16, thus, the MT first connects to the WBS A and communicates with the WBS A (171). Then, the MT transmits a signal to notify of desired communication requirements to communicate with WBS, such as a desired communication rate and the moving speed of the MT to the WBS A (172). The WBS A transfers the received information to the WBS communication manager (173). The WBS communication manager determines a priority order of WBSs with which the MT should communicate next, taking account of both the communication requirements sent from the MT and the loads of the WBSs (174) and notifies the WBS A of information on the WBSs and the determined priority order (175). The WBS A transmits a signal to notify of the information on the WBSs, priority order, and transmit timing toward the particular MT to be handovered (176). The WBS communication manager also notifies WBSs in the top priority group of timing when the MT that needs to be handovered is to transmit a signal for connection (177). The MT transmits a signal for connection to the WBSs in the top priority group according to the specified timing (178). Subsequent operation is the same as is the case for other embodiments already described.

In the present embodiment, the WBS communication manager determines a priority order of WBSs to which the MT should transmit a signal for connection. Thus, the WBS communication manager can know timing when it is to receive a notification of reception result of a signal for connection from which ones of the WBSs under management. If the WBS communication manager does not receive a notification of reception result of a signal for connection from any WBS at timing when the reception is anticipated, it is arranged to communicate information on the MT that should transmit a signal for connection and transmit timing toward WBSs in the second priority group. Likewise, if the MT does not receive a response signal from any of the WBSs in the top priority group, the MT is arranged to transmit a signal for connection to the WBSs in the second priority group at predetermined timing. If there is no WBS that is more suited as a handover target than the WBS A, the MT is to continue communication with the WBS A.

Because the WBS communication manager determines WBSs to which the MT may be handovered in the present embodiment, it is possible to determine a priority order taking account of, inter alia, the loads of the WBSs. Thus, there is a possibility that the system-wide wireless resources can be used more efficiently than in the case in which the MT determines a priority order. The loads of the WBSs mean, for example, the number of MTs now served by each WBS, included in information that is managed by the WBS communication manager.

As described above, in the fourth embodiment, the MT is first connected to the WBS A that uses the lowest frequency among the WBSs. Then, the WBS communication manager determines a priority order of WBSs to which the MT should connect newly, taking account of both the loads of the WBSs and the communication requirements of the MT and notifies the MT of the determined priority order. Thus, the wireless resources throughout the wireless communication system can be used more efficiently. Although it is arranged that the MT is first connected to the WBS A that uses the lowest frequency, it may be arranged that the MT is first connected to a WBS having the widest coverage area among the WBSs managed by the WBS communication manager.

### Fifth Embodiment

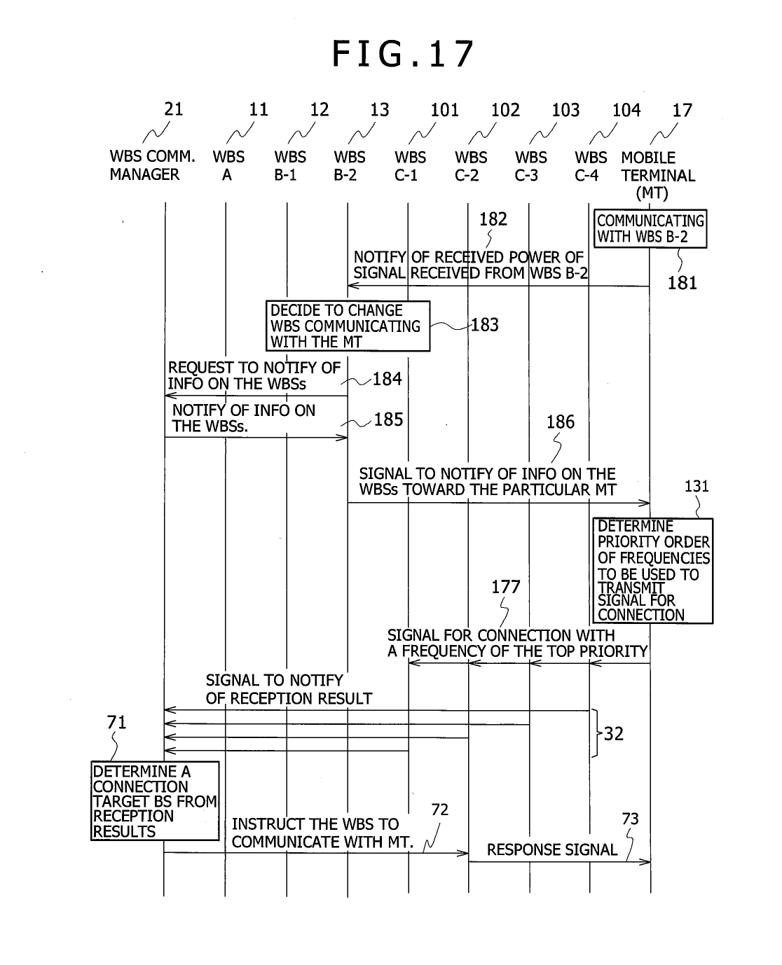

An operation sequence among a mobile terminal (MT), WBSs, and the WBS communication manager according to a fifth embodiment is described using FIG. 17. In the fifth embodiment, the operation sequence is presented in a situation below: when the MT communicates with a WBS that uses a higher frequency for communication than the WBS A, the signal received power from the WBS has decreased due to relocation of the MT or change in the radio propagation environment; thus, the serving WBS determines that it is necessary to handover the MT to an WBS that uses another frequency or another WBS that uses the same frequency.

In an example depicted in FIG. 17, the MT communicates with a WBS B-2 (181) and periodically notifies the WBS B-2 of signal received power from the WBS B-2 (182). If the received power measurement result has decreased below a threshold that is set by the WBS B-2, the WBS B-2 determines to change the WBS with which the MT communicates (183). Then, the WBS B-2 requests the WBS communication manager to notify of information on the WBSs (184). The WBS communication manager notifies the WBS B-2 of information on the WBSs (185). Then, the WBS B-2 transmits a signal to notify of the information on the WBSs to the MT that needs to be handovered as the signal toward the particular MT (186). Upon receiving this signal, the MT determines a priority order of frequencies to be used to transmit a signal for connection (131) and transmits a signal for connection using a frequency of the top priority (177). The operation that follows is the same as is the case for other embodiments already described.

In the fifth embodiment, it is arranged that the MT is notified of the information on the WBSs from the WBS B-2 (serving WBS) with which the MT is now communicating. For example, if, after the MT first connects to the WBS A, the MT is handovered to the WBS B-2 and is communicating with the WBS B-2, as in the fourth embodiment, the MT has already been notified of the information on the WBSs during the communication with the WBS A. Thus, when the MT is handovered from the WBS B-2 to another WBS, it should preferably be arranged so that only an updated portion of the information notified from the WBS A is notified to the MT.

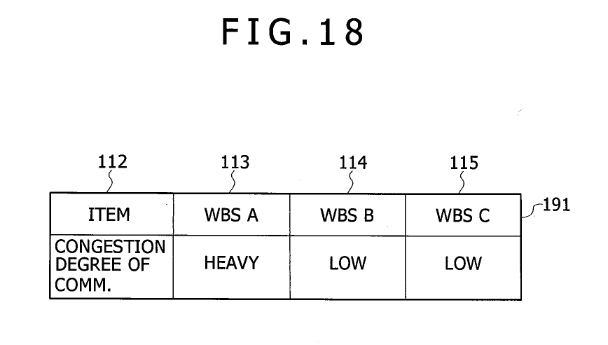

Updated information is, for example, the congestion degree of communication 191 with respect to each WBS, as presented in FIG. 18. Since the congestion degree of communication is information that varies over time, it may preferably be arranged so that each WBS periodically notifies the WBS communication manager of the information of the congestion degree of communication to enable timely updation. Information on the WBSs, as also presented in FIG. 11, can be roughly divided into static information such as used frequency, the number of WBSs using that frequency, maximum communication rate of WBS using that frequency, and supportable moving speed of MT; and variable information that varies over time, such as the congestion degree with respect to each WBS. Therefore, it is not necessary to transmit variable information and static information to the MT at the same intervals. It may also be arranged to transmit these types of information separately. In the fifth embodiment, it should be arranged so that only variable information is transmitted to the MT that is handovered from the WBS B-2 to another WBS. As described in the foregoing, when the MT is communicating with a WBS other than the WBS A, it is arranged that the information on the WBSs is notified from the serving WBS to the MT. Thereby, it becomes unnecessary for the MT to reconnect to the WBS A each time it is handovered. By transmitting only variable information, the used wireless resources can be reduced as compared with a case of transmitting static information and variable information. While the example in which the serving WBS makes a handover decision has been described in the present embodiment, it may also be arranged so that the MT makes a handover decision.

### Sixth Embodiment

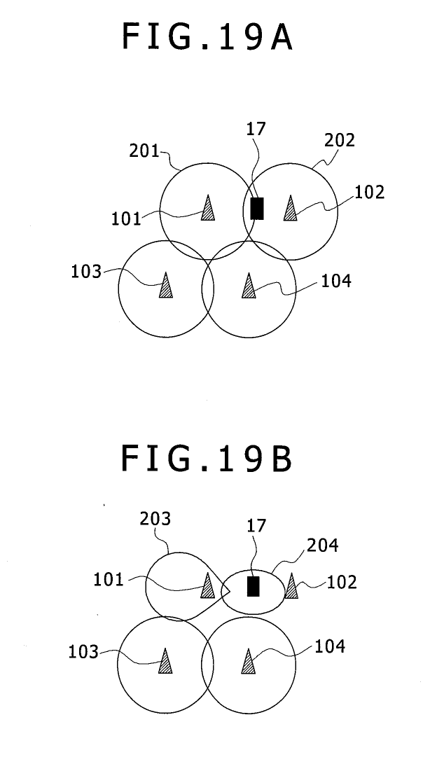

Antenna beam forming of the WBSs according to a sixth embodiment is described using FIGS. 19A and 19B. In the present embodiment, it is arranged so that a signal for connection transmitted by a mobile terminal (MT) using a frequency is received by all WBSs that can receive the signal with that frequency. For example, as depicted in FIG. 19A, in a case in which four WBSs C-1 to C-4 using the frequency C are deployed adjacently and there is a mobile terminal (MT) in the boundary between the cells of the WBS C-1 and WBS C-2, the WBS communication manager can estimate the location of the MT from the reception results of the signal for connection notified respectively from the WBSs C-1 to C-4. In the present embodiment, the WBSs have an array antenna function capable of forming a directional beam toward a direction in which a particular MT is located. For example, if the WBS communication manager has determined the WBS C-2 as the serving WBS to communicate with the MT, the WBS C-2 (102) sets its antenna beam pattern (204) directed toward the MT (17) for signal transmission to the MT 17, as depicted in FIG. 19B. Thereby, the received power of the MT can be increased as compared with a case in which the WBS performs communication with a beam pattern (202) to cover all directions, as in FIG. 19A.

In this case, the strength of radio propagating toward the WBS C-1 from the WBS C-2 becomes larger than in the case of FIG. 19A. Therefore, in order to prevent interference between adjacent cells, it is more preferable that the direction of the beam (201) transmitted by the WBS C-1 (201) is adjusted so that the beam is directed to go away from the WBS C-2 (203).

In the case in which the WBSs C have the function of changing the direction of the beam transmitted by the array antenna, as presented in the sixth embodiment, when the WBSs receive a signal for connection from a mobile terminal (MT), they cannot detect the location of the MT. Therefore, it is preferable that the WBSs receive the signal with a beam pattern to cover all directions, as in FIG. 19A. However, if it is possible to estimate the location of the MT and direct the beam toward the MT, the received power of the MT can be increased by directing the beam toward the MT and communication can be performed in good condition.

While the embodiments of the present invention have been described hereinbefore, it is obvious that the present invention and its configurations are not limited to these embodiments and various modifications may be made therein without departing from the spirit of the invention.

What is claimed is:

1. A wireless communication system comprising:
a mobile terminal;
a first wireless base station (hereinafter abbreviated to WBS) that uses a first frequency band to communicate with the mobile terminal;
a plurality of second WBSs that use a second frequency band which is different from the first frequency band to communicate with the mobile terminal; and
a WBS communication manager connected to the first WBS and the second WBSs,
wherein a coverage area of the first WBS is overlapped partially at least by a coverage area of the second WBSs,
wherein the mobile terminal transmits a signal for connection using a predetermined frequency,
wherein the second WBSs, upon receiving the signal for connection, each notify the WBS communication manager of their reception results of the signal for connection, and
wherein the WBS communication manager selects a second WBS to communicate with the mobile terminal based on the reception results and notifies the selected second WBS to transmit a response signal to the signal for connection to the mobile terminal.

2. The wireless communication system according to claim 1,
wherein the mobile terminal transmits the signal for connection using a frequency that is different from the predetermined frequency, if having not received a response signal within a pre-configured period of time.

3. The wireless communication system according to claim 1,
wherein the WBS communication manager notifies the mobile terminal of information of respective frequencies that are used by the first WBS and the second WBSs as information on the WBSs.

4. The wireless communication system according to claim 3,
wherein the information on the WBSs is transmitted from an WBS having the largest coverage area or an WBS that uses the lowest frequency among the WBSs managed by the WBS communication manager to the mobile terminal.

5. The wireless communication system according to claim 3,
wherein, as the information on the WBSs, at least any one of the following items of information is notified: moving speed of a mobile terminal supportable by the first WBS and the second WBSs; a maximum communication rate of the first WBS and the second WBSs; and the number of the first WBS and the second WBSs.

6. The wireless communication system according to claim 3,
wherein the information on the WBSs comprises variable information which varies over time and static information which does not vary over time, and
wherein the WBS communication manager notifies of the variable information and the static information separately.

7. The wireless communication system according to claim 6,
wherein the variable information can be transmitted from any of the WBSs managed by the WBS communication manager to the mobile terminal.

8. The wireless communication system according to claim 5,
wherein the mobile terminal determines a priority order of frequencies to transmit the signal for connection, based on the information on the WBSs.

9. The wireless communication system according to claim 1,
wherein the WBS communication manager determines a priority order of frequencies to be used for the mobile terminal to transmit the signal for connection, based on information on communication requirements of the mobile terminal and information of loads of the WBSs.

10. The wireless communication system according to claim 1,
wherein the WBS communication manager is provided inside an WBS that uses the lowest frequency.

11. The wireless communication system according to claim 1,
wherein the mobile terminal transmits the signal for connection, when the mobile terminal has moved into the coverage area of an WBS managed by the WBS communication manager from the coverage area of an WBS not managed by the WBS communication manager.

12. The wireless communication system according to claim 1,
wherein the mobile terminal transmits the signal for connection, when a connection is switched from one of the WBSs managed by the WBS communication manager to another one of the WBSs managed by the WBS communication manager.

13. The wireless communication system according to claim 1,
wherein the WBS communication manager estimates the location of the mobile terminal from a plurality of reception results of the signal for connection, and
wherein one of the second WBSs that communicates with the mobile terminal changes a beam pattern to direct the beam toward a direction in which the mobile terminal is located, based on the estimated location of the mobile terminal.

14. A wireless communication method for use in a wireless communication system comprising a mobile terminal, a first WBS that uses a first frequency band to communicate with the mobile terminal, and a plurality of second WBSs that use a second frequency band which is different from the first frequency band to communicate with the mobile terminal, the wireless communication method comprising:
transmitting, by the mobile terminal, a signal for connection using a predetermined frequency;
receiving, by each of the second WBSs, the signal for connection; and
selecting a second WBS to communicate with the mobile terminal based on reception results of the signal for connection and notifying the selected second WBS to transmit a response signal to the signal for connection to the mobile terminal.

15. A wireless base station (WBS) that uses a first frequency band to communicate with a mobile terminal
wherein a coverage area of the first WBS is overlapped partially at least by a coverage area of other WBSs that use a second frequency band which is different from the first frequency band,
wherein the WBS comprises an WBS communication manager that manages the other WBSs, and
wherein the WBS communication manager receives, from each of the other WBSs, reception results of a signal for connection transmitted by the mobile terminal using a predetermined frequency, selects an WBS to communicate with the mobile terminal based on the reception results, and notifies the selected WBS to transmit a response signal to the signal for connection to the mobile terminal.
